(19) United States
(12) Patent Application Publication
(10) Pub. No.: US 2010/0284817 A1
(43) Pub. Date: Nov. 11, 2010

(54) METHOD FOR PRODUCING A BLISK OR A BLING, COMPONENT PRODUCED THEREWITH AND TURBINE BLADE

(76) Inventors: Joachim Bamberg, Dachau (DE); Karl-Hermann Richter, Markt Indersdorf (DE); Thomas Uihlein, Dachau (DE); Joachim Wulf, Muenchen (DE)

Correspondence Address: CROWELL & MORING LLP;INTELLECTUAL PROPERTY GROUP, P.O. BOX 14300, WASHINGTON, DC, 20044-4300, US

(21) Appl. No.: 12/738,608

(22) PCT Filed: Oct. 10, 2008
(86) PCT No.: PCT/DE08/01667

§ 371 Date: Jul. 23, 2010

(30) Foreign Application Priority Data
Oct. 19, 2007 (DE) 10 2007 050 142.2

(51) Int. Cl. F01D 5/14; B23P 15/02

(52) U.S. Cl. 416/241 R; 29/889.7

(57) ABSTRACT

A method for producing a blisk (bladed disk) or a bling (bladed ring) of a gas turbine is disclosed. The method includes the following steps: a) producing a turbine blade by joining a blade to an adapter element consisting of a metal material that is suitable for fusion welding, the adapter element being used to form a blade root of the turbine blade, and b) joining the turbine blade to a rotor disk consisting of a metal material that is suitable for fusion welding or to a rotor ring consisting of a metal material that is suitable for fusion welding in such a manner that the turbine blade is arranged on the outer periphery of the rotor disk or of the rotor ring. A component of a gas turbine or of a high-pressure or low-pressure compressor, especially a blisk or bling, and a turbine blade are also disclosed.

This application claims the priority of International Application No. PCT/DE2008/001667, filed Oct. 10, 2008, and German Patent Document No. 10 2007 050 142.2, filed Oct. 19, 2007, the disclosures of which are expressly incorporated by reference herein.

### BACKGROUND AND SUMMARY OF THE INVENTION

The present invention relates to a method for producing a blisk (bladed disk) or a bling (bladed ring) of a gas turbine. The invention also relates to a component produced by means of the method as well as a turbine blade consisting of a blade and a blade root.

Blisk (bladed disk) and bling (bladed ring) designate rotor designs, where blades are produced integrally with a supporting disk or a supporting ring. The advantage of these rotor designs is that the disks or ring shape can be optimized for low boundary stress and as a whole produces to a lower weight of the corresponding components. In this case, compressor blisks are produced from titanium-based or nickel-based alloys, in particular by milling as well as sporadically by linear friction welding or electrochemical removal. In the case of compressor blisks, the material for the disks and blades is generally identical. On the other hand, the disk and blade materials in the area of the turbine must be different from one another in order to be able to satisfy the mechanical and thermal requirements. As a result, turbine blades produced by casting technology feature a polycrystalline, directionally solidified or monocrystalline structure and are not suitable for fusion welding due to the very high y′ proportion in the material. In contrast, turbine disks are frequently fabricated of materials suitable for fusion welding, such as Inconel 718 for example. As a result, turbine blisks may only be realized using joining technology. In this case, it must be taken into account, however, that joining methods, such as, for example, linear friction welding, are not suitable or are only somewhat suitable for producing these types of turbine blisks due to the required compressive forces. The same applies to blings. Because of the cited limitations, the known production methods can only be used in a limited manner. In addition, the known methods are to some extent very involved and go hand in hand with correspondingly high cost expenditures.

As a result, the objective of the present invention is to make available a generic method for producing a blisk (bladed disk) or a bling (bladed ring) of a gas turbine, which can be carried out relatively simply and cost-effectively.

In addition, the objective of the present invention is to make available a generic component which can be produced relatively simply and cost-effectively.

Furthermore, the objective of the present invention is to make available a turbine blade, which can be produced relatively simply and cost-effectively.

A method for producing a blisk (bladed disk) or a bling (bladed ring) of a gas turbine in accordance with the invention includes the following steps: a) producing at least one turbine blade by joining a blade to an adapter element consisting of a metallic material that is suitable for fusion welding, the adapter element being used to form a blade root of the turbine blade and b) connecting the turbine blade or a plurality of turbine blades to a rotor disk consisting of a metallic material suitable for fusion welding or to a rotor ring consisting of a metallic material suitable for fusion welding in such a manner that the turbine blade(s) is/are arranged on the outer periphery of the rotor disk or of the rotor ring. Because of producing the turbine blade according to the invention from a blade and an adapter element suitable for fusion welding arranged thereto, it is possible to advantageously dispense with known joining methods such as pressure welding methods, high-temperature soldering or diffusion soldering during the production of the turbine ring. By returning to the fundamental task during the production of a blisk or a bling, namely the joining of cast blades to forged disks or rings with a minimum number of established joining methods, the inventive method can be carried out simply and cost-effectively. Thus, on the one hand, the production of the turbine blade according to process step a) takes place by means of a pressure welding method, an inductive low-frequency or high-frequency pressure welding method, a linear friction welding method or a diffusion welding method.

In an advantageous embodiment of the method according to the invention, prior to process step b), a production of an annular blade ring from a plurality of turbine blades produced according to process step a) takes place, wherein in process step b) a connecting of the annular blade ring to the rotor disk consisting of a metallic material suitable for fusion welding or to the rotor ring consisting of a metallic material suitable for fusion welding is carried out such that the blade ring is arranged on the outer periphery of the rotor disk or of the rotor ring. As a result, a relatively simple method (in terms of manufacturing technology) for producing a blisk (bladed disk) or a bling (bladed ring) of a gas turbine is guaranteed. The formation of the blade ring takes place advantageously by a segment-by-segment joining of the adapters configured as blade roots to the individual turbine blades. Because the adapters are made of a metallic material suitable for fusion welding, a fusion welding method, in particular an electron beam welding process, can be used for this. The same also applies for connecting the turbine blades or the annular blade ring to the rotor disk or to the rotor ring, which are also made of a metallic material suitable for fusion welding. According to the invention, the same joining process, namely a fusion welding method, in particular an electron beam fusion welding process, can be used advantageously for this purpose. According to another embodiment of the invention, the material of the adapter element can correspond to the material of the rotor disk and of the rotor ring. In particular, the material in this case is a wrought alloy or forged material component, in particular a high-temperature-resistant nickel alloy. The material of the blades, on the other hand is made of a cast alloy, in particular a high-temperature-resistant nickel alloy.

In another embodiment of the method in accordance with the invention, the positioning of the blade ring on the rotor disk or on the rotor ring takes place by means of shrinking. In order to guarantee this, the blade ring, the rotor disk and the rotor ring feature the necessary radii. Because of the shrinking, an intimate connection is guaranteed between the individual elements of the blisk or the bling.

In a further advantageous embodiment of the method in accordance with the invention, after connecting the turbine blades or the annular blade ring to the rotor disk or to the rotor ring, those regions of the turbine blades or of the blade ring that lie between the individual turbine blades are partially removed in such a way that only a respective root section of the corresponding blade is still connected to the rotor disk or to the rotor ring. But it is also possible, after connecting the turbine blades or the annular blade ring to the rotor disk or to the rotor ring, for those regions of the turbine blades or of the blade ring that lie between the individual turbine blades to be removed in such a way that a welded seam, which is configured between the turbine blades or the blade ring and the rotor disk or the rotor ring, to be partially removed and interrupted. The removal of the intermediate areas of the turbine blades or the blade ring and/or the rotor disk or the rotor ring is carried out, for example, by means of an electrochemical removal process and/or an electro-erosive removal process (electrical discharge machining). But other methods can also be used such as, for example, drilling or milling processes.

A component of a gas turbine in accordance with the invention, in particular a blisk (bladed disk) or a bling (bladed ring) consists of separately produced turbine blades or an annular blade ring produced from a plurality of separately produced turbine blades and a rotor disk connected thereto and consisting of a metallic material suitable for fusion welding, or a rotor ring connected thereto and consisting of a metallic material suitable for fusion welding, the turbine blades or the blade ring being arranged on the outer periphery of the rotor disk or of the rotor ring and the turbine blades consisting of respective blades and adapter elements consisting of a metallic material suitable for fusion welding fastened thereto, and the adapter element being configured to form a blade root of the turbine blade. Because of the embodiment of the component in accordance with the invention, in particular the embodiment of the turbine blades, it is possible to produce the component relatively easily and cost-effectively. In particular, when producing the component, the number of different joining methods can be clearly reduced as compared to the previously known production methods. Because of the embodiment of the blade root or the adapter element of a metallic material suitable for fusion welding, these can be joined by means of a fusion welding method, in particular an electron beam fusion welding process, to the blade ring consisting of a plurality of turbine blades. The same joining methods can be used for connecting the individual turbine blades or the blade ring to the corresponding rotor disk or the corresponding rotor ring, because they are also made of a metallic material suitable for fusion welding. In this case, the material of the adapter element can correspond to the material of the rotor disk or of the rotor ring. In an advantageous embodiment of the invention, the material can be a wrought alloy, in particular a high-temperature-resistant nickel alloy. The connection of the blade to the adapter element is normally carried out by means of a pressure welding method, an inductive low-frequency or high-frequency pressure welding method, a linear friction welding method or a diffusion welding method, because the material of the blade is normally not suitable for fusion welding and can be made of a cast alloy, in particular a high-temperature-resistant nickel alloy.

In an advantageous embodiment of the component in accordance with the invention, the component features at least one cover band for shielding the rotor disk or the rotor ring. The cover band in this case is used in particular to shield the hot gas in the gas turbine. In addition, the component can feature an external cover band.

In particular, the components in accordance with the invention can be produced according to one of the methods described in the foregoing.

An inventive turbine blade of a gas turbine is made of a blade and a blade root, wherein the blade is made of a metallic material that is not suitable for fusion welding and the blade root is made of a metallic material suitable for fusion welding. Because of the two-part embodiment of the turbine blade in accordance with the invention, on the one hand, a relatively simple and cost-effective production of the turbine blade is guaranteed. In addition, because of the formation of the blade root of a metallic material suitable for fusion welding, additional advantages are yielded for further use and in particular in the production of a turbine blade ring of a plurality of turbine blades, because corresponding joining of the individual turbine blades can be carried out without the aid, for example, of pressure welding methods or the conventional soldering methods. There is weldability between the individual blades as compared to known turbine blades. In this case, the blade root in particular is configured as a separate adapter element such that a plurality of adapter elements connected to one another form a ring of a turbine blade ring. In an advantageous embodiment of the invention, the blade is made of a cast alloy and the adapter element is made of a wrought alloy. The wrought alloy and/or the cast alloy can in this case be a high-temperature-resistant nickel alloy.

The methods in accordance with the invention described in the foregoing, the components in accordance with the invention and the turbine blades in accordance with the invention are also used in the repair of a blisk (bladed disk) or a bling (bladed ring) of a gas turbine.

Additional advantages, features and details of the invention are yielded from the following description of several graphically depicted exemplary embodiments.

### BRIEF DESCRIPTION OF THE DRAWINGS

FIG. 1 is a schematic representation of a turbine blade in accordance with the invention as part of a component according to the invention;

FIG. 2 is a schematic representation of a blade ring joined in accordance with the invention;

FIG. 3 is a schematic representation of a component joined in accordance with the invention according to a first embodiment;

FIG. 4 is a schematic representation of a component joined in accordance with the invention according to second embodiment; and

FIG. 5 is a schematic representation of a component joined in accordance with the invention according to a third embodiment.

### DETAILED DESCRIPTION OF THE DRAWINGS

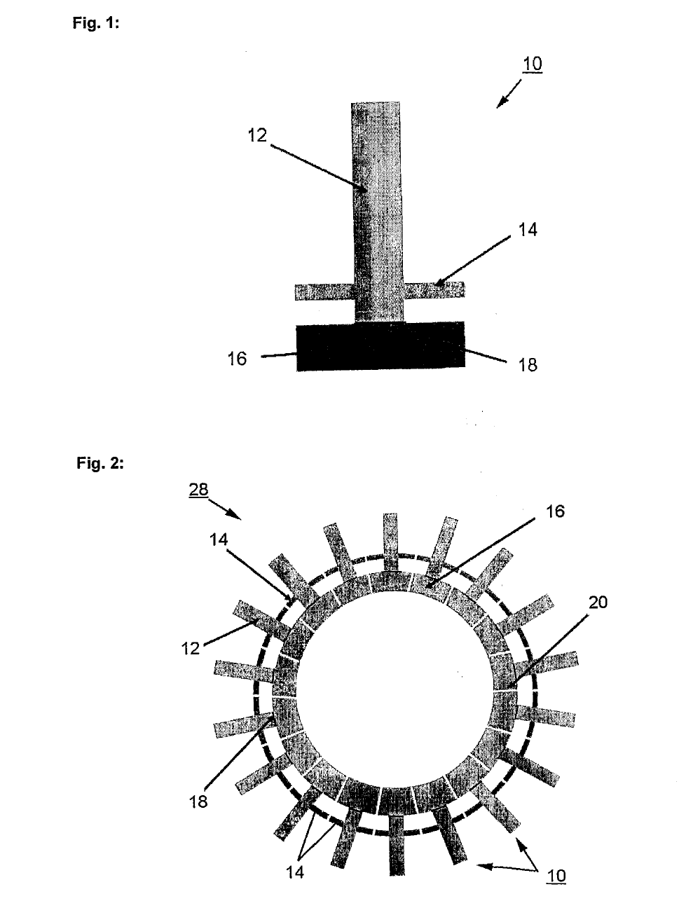

FIG. 1 shows a schematic representation of a turbine blade 10 as part of a gas turbine, in particular as part of a blisk or a bling. The figure shows that the turbine blade 10 features a two-part structure. A blade 12 consisting of a metallic material that is not suitable for fusion welding is connected in this case to an adapter element 16 via a first welded seam 18. The adapter element 16 in this case forms a blade root of the turbine blade 10. Joining the blade 12 to the adapter element 16 is carried out either by a pressure welding method, in particular linear friction welding, or an inductive high-frequency pressure welding or even by a diffusion welding method. The blade 12 is made of a cast alloy, in particular a high-temperature-resistant nickel alloy. The adapter element 16 also consists of high-temperature-resistant nickel alloy, however, the alloy is configured as a wrought alloy. In addition, the turbine blade features elements of an internal cover band 14.

FIG. 2 shows a schematic representation of a turbine blade ring 28 joined from the turbine blades 10 shown in FIG. 1. It shows that a plurality of adapter elements 16 connected to one another form a ring of the turbine blade ring 28. The individual adapter elements 16 in this case are joined to one another via corresponding second welded seams 20. The joining in this case can be carried out by means of a fusion welding method, in particular an electron beam fusion welding process. One can see that the second welded seams run in the radial direction, wherein the respective side surfaces of the adapter elements 16 are joined. Because low-pressure turbine rotor blades generally have an external and an internal cover band 14, electron beam welding must be carried out from the interior to the exterior. As a result, the angle of the electron beam with respect to the rotational axis is less than 90°, the effective welded-in depth is indicated by t/sin α, wherein t is the height of the adapter element 16 and α is the angle between the rotational axis and the electron beam. In addition, one can see that the sub-elements 14 form a circumferential internal cover band 14 when the blade ring 28 is in a joined-together state.

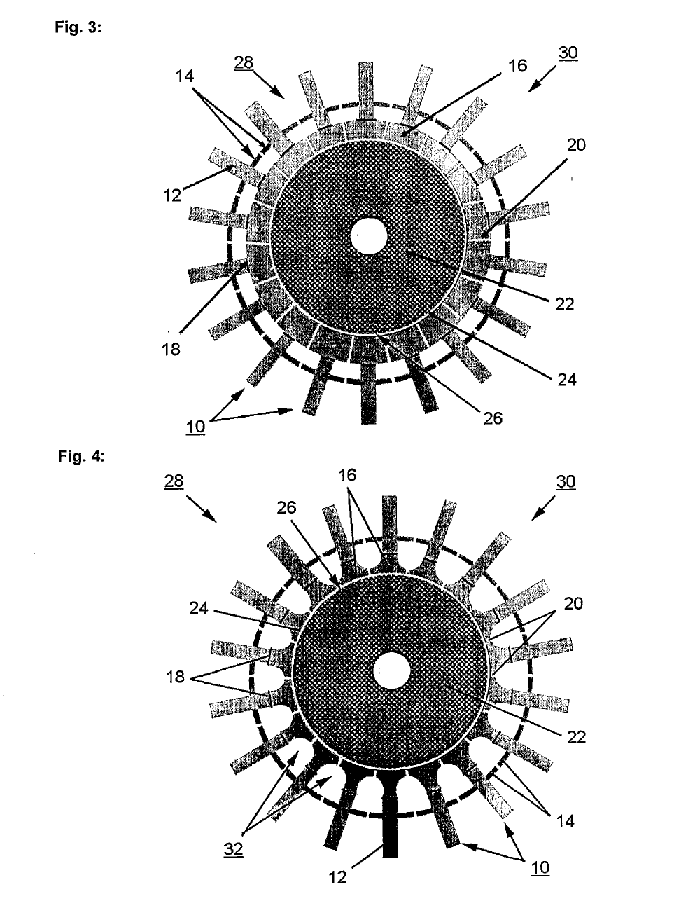

FIG. 3 shows a schematic representation of a joined component 30, namely a blisk, consisting of a rotor disk 22 and the turbine ring 28 joined on the outer periphery 26 of the rotor disk 22. In this case, the positioning of the blade ring 28 on the rotor disk 22 is preferably carried out by means of shrinking. The connection of the annular blade ring 28 to the rotor disk 22 is in turn carried out by means of a joining process, namely a fusion welding method such as an electron beam welding process. The third welded seam 24 that forms is either axial or slightly conical. In the first case (see FIG. 3), the electron beam source is positioned in a fixed manner above a point of the to-be-joined seam 24. In the second case, the electron beam source is positioned above the rotational axis. Through rapid beam deflection in the latter case several (e.g., three) individual beams are generated, which are offset by 120° in the circumferential direction, while the component 30 is rotated 360° on a rotary table. In the process, the axial distortion can be minimized. FIG. 3 shows a first embodiment of the component 30. The adapter elements 16, which serve as blade roots of the turbine blades 10, are configured here in such a way that no further post-processing is necessary.

FIG. 4 in contrast shows a second embodiment of the component 30. The component 30 according to the second embodiment is also a blisk. In contrast to the embodiment depicted in FIG. 3, in this case, however, after connecting the annular blade ring 28 to the rotor disk 22, those regions of the blade ring 28 that lie between the individual turbine blades 10 are partially removed in such a way that only a respective root section 32 of the corresponding blade 10 is still connected to the rotor disk 22. Removal of these intermediate areas of the blade ring 28 in this case can be carried out by means of a milling process and/or an electrochemical removal process and/or an electro-erosive removal process.

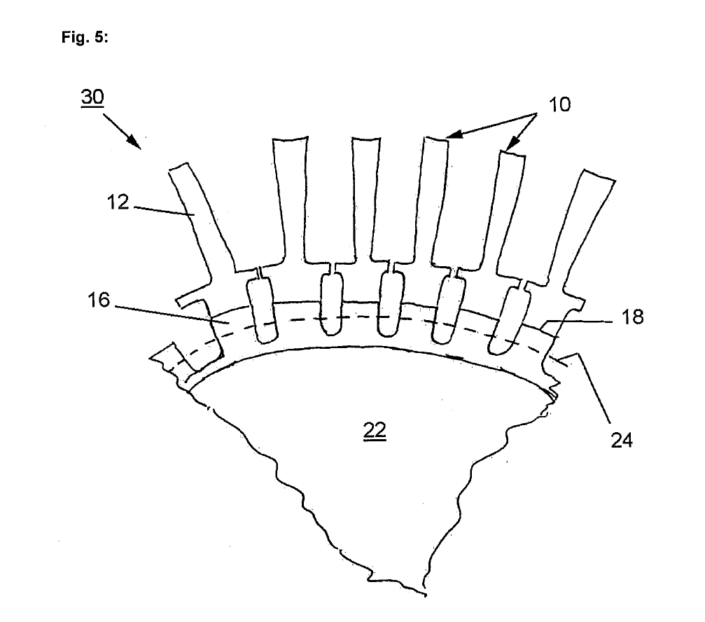

FIG. 5 shows a third embodiment of the component 30. The component 30 according to the third embodiment is also a blisk. In contrast to the embodiment depicted in FIG. 4, in this case the turbine blades 10 were connected directly to the rotor disk 22 without previously producing a blade ring 28. After connecting the turbine blades 10 to the rotor disk 22, those regions of the turbine blades 10 that lie between the individual turbine blades 10 are partially removed in such a way that only the welded seam 24, which is configured between the turbine blades 10 and the rotor disk 22, is partially removed and interrupted.

The exemplary embodiments depicted make it clear that the originating joining zones can be tested 100% with known non-destructive testing techniques. Even machining off any possible welding beads is possible in a simple manner.

1.-25. (canceled)

26. A method for producing a blisk (bladed disk) or a bling (bladed ring) of a gas turbine, comprising the steps of:
a) producing a turbine blade by welding a blade consisting of a material that is not suitable for fusion welding to an adapter element consisting of a metallic material that is suitable for fusion welding, wherein the adapter element forms a blade root of the turbine blade; and
b) welding the turbine blade to a rotor disk consisting of a metallic material suitable for fusion welding or to a rotor ring consisting of a metallic material suitable for fusion welding in such a manner that the turbine blade is arranged on an outer periphery of the rotor disk or of the rotor ring;
wherein the step of producing the turbine blade by welding takes place by a pressure welding method, an inductive low-frequency or high-frequency pressure welding method, a linear friction welding method or a diffusion welding method.

27. The method according to claim 26, wherein prior to step b), an annular blade ring is produced from a plurality of turbine blades produced according to step a) and wherein in process step b) the annular blade ring is welded to the rotor disk or to the rotor ring such that the blade ring is arranged on the outer periphery of the rotor disk or of the rotor ring.

28. The method according to claim 27, wherein the blade ring is produced by a segment-by-segment joining of the respective adapter elements of the plurality of turbine blades.

29. The method according to claim 28, wherein the joining is a fusion welding method.

30. The method according to claim 26, wherein the welding of step b) is a fusion welding method.

31. The method according to claim 27, further comprising the step of positioning the blade ring on the rotor disk or on the rotor ring by shrinking.

32. The method according to claim 27, wherein after welding the blade ring to the rotor disk or to the rotor ring, regions of the blade ring that lie between individual turbine blades are partially removed such that only a respective root section of a corresponding blade is connected to the rotor disk or to the rotor ring.

33. The method according to claim 26, wherein after welding the turbine blades to the rotor disk or to the rotor ring, regions of the turbine blades that lie between individual turbine blades are partially removed such that a welded seam, which is configured between the turbine blades and the rotor disk or the rotor ring, is partially removed and interrupted.

34. The method according to claim 33, wherein the removal is carried out by a milling process and/or an electrochemical removal process and/or an electro-erosive removal process.

35. The method according to claim 26, wherein the metallic material of the adapter element corresponds to the metallic material of the rotor disk or of the rotor ring.

36. The method according to claim 35, wherein the metallic material is a wrought alloy.

37. A component of a gas turbine, in particular a blisk (bladed disk) or a bling (bladed ring), comprising:
separately produced turbine blades or an annular blade ring produced from a plurality of separately produced turbine blades; and
a rotor disk welded to the turbine blades or the annular blade ring and consisting of a metallic material suitable for fusion welding, or a rotor ring welded to the turbine blades or the annular blade ring and consisting of a metallic material suitable for fusion welding;
wherein the turbine blades or the annular blade ring is arranged on an outer periphery of the rotor disk or of the rotor ring;
wherein each of the turbine blades includes a blade formed of a material that is not suitable for fusion welding and an adapter element formed of a metallic material suitable for fusion welding welded to the blade, wherein the adapter element forms a blade root of the turbine blade;
and wherein the adapter is welded to the blade of each turbine blade by a pressure welding method, an inductive low-frequency or high-frequency pressure welding method, a linear friction welding method or a diffusion welding method.

38. The component according to claim 37, further comprising a cover band attached to the turbine blades for shielding the rotor disk or the rotor ring.

39. The component according to claim 37, wherein the metallic material of the adapter element corresponds to the metallic material of the rotor disk or of the rotor ring.

40. The component according to claim 39, wherein the material is a wrought alloy.

41. The component according to claim 37, wherein the material of the blade is a cast alloy.

42. The component according to claim 37, further comprising an external cover band attached to the turbine blades.

43. The component according to claim 37 produced in accordance with the method according to claim 26.

44. A turbine blade of a gas turbine, comprising:
a blade; and
a blade root;
wherein the blade is made of a metallic material that is not suitable for fusion welding and the blade root is made of a metallic material suitable for fusion welding.

45. The turbine blade according to claim 44, wherein the blade root is configured as a separate adapter element and wherein a plurality of adapter elements of a plurality of blades are connected to one another to form a ring of a turbine blade ring.

46. The turbine blade according to claim 45, wherein the blade is made of a cast alloy and the adapter element is made of a wrought alloy.

47. The turbine blade according to claim 46, wherein the wrought alloy and/or the cast alloy are/is a high-temperature-resistant nickel alloy.

48. Use of a method according to claim 26, of a component according to claim 37, or of a turbine blade according to claim 44 for repairing a blisk (bladed disk) or a bling (blade ring) of a gas turbine.
